(19) United States
(12) Patent Application Publication
(10) Pub. No.: US 2026/0301110 A1
(43) Pub. Date: Oct. 1, 2026

(54) SYSTEMS AND METHODS FOR GPU-ACCELERATED COST CALCULATION

(71) Applicant: AVRIDE Inc., Newburyport, MA (US)

(72) Inventors: Aliaksei Dzichkouski, Tel Aviv (IL); Roman Udovichenko, Austin, TX (US)

(21) Appl. No.: 19/577,633

(22) Filed: Mar. 25, 2026

Related U.S. Application Data
(60) Provisional application No. 63/777,175, filed on Mar. 25, 2025.

(51) Int. Cl. G06T 1/20; G01C 21/34

(52) U.S. Cl. CPC G06T 1/20; G01C 21/34

(57) ABSTRACT

The techniques described herein relate to a system and method for GPU-accelerated cost calculation, the system including: at least one processor; and a memory communicatively connected to the at least one processor and containing instructions configuring the at least a processor to: receive a road dataset and an object dataset; construct, using a graph construction algorithm, as a function of the road dataset and the object dataset, a lattice; and determine costs for one or more of the plurality of vertices and the plurality of edges; and determine an optimal path as a function of the costs of the one or more of the plurality of vertices and the plurality of edges and a pathfinding algorithm.

### CROSS REFERENCE TO RELATED APPLICATIONS

This application claims the benefit of priority to U.S. Provisional Patent Application No. 63/777,175, filed on Mar. 25, 2025, and entitled “METHOD AND SYSTEM FOR GPU-ACCELERATED COST CALCULATION IN GRAPH BASED MOTION PLANNING FOR AUTONOMOUS VEHICLES,” the entirety of which is incorporated herein by reference.

### FIELD OF THE INVENTION

The present invention is directed generally GPU-accelerated computation and, more particularly, to systems and methods for GPU-accelerated cost calculation.

### BACKGROUND OF THE INVENTION

Historically, traditional graphics processing unit based sequential processing methods are used for cost calculation. However, the traditional approach employed historically fails to provide real-time trajectory calculation. This is a disadvantage because it requires a large amount of computation time to calculate trajectories.

Therefore, the need exists for an improved method and system for GPU-accelerated cost calculation that significantly reduces computation time while enabling real-time trajectory generation for autonomous vehicles operating in complex environments.

### SUMMARY

In some aspects, the techniques described herein relate to a system for GPU-accelerated cost calculation, the system including: at least one processor including a graphical processing unit (GPU); and a memory communicatively connected to the at least one processor and containing instructions configuring the at least a processor to: receive a road dataset and an object dataset including predicted agent trajectories; construct, using a graph construction algorithm, as a function of the road dataset and the object dataset, a lattice, wherein the lattice includes: a plurality of vertices each vertex representing a kinematic pose defined by at least a position, an orientation, and a curvature at a lateral offset from a reference path; and a plurality of edges connecting at least a portion of the plurality of vertices, wherein each edge of the plurality of edges includes a kinematically feasible trajectory between kinematic poses; determine costs for one or more of the plurality of vertices and the plurality of edges, wherein determining the costs includes: a first stage including a plurality of edge cost operations executed in parallel across all of the plurality of edges of the lattice, wherein each GPU thread is assigned to one edge and is configured to compute a plurality of heterogeneous costs for that edge; and a second stage including a path cost computation executed cooperatively within GPU thread blocks; and determine an optimal path as a function of the costs of the one or more of the plurality of vertices and the plurality of edges and a pathfinding algorithm.

In some aspects, the techniques described herein relate to a method for GPU-accelerated cost calculation, the method including: receiving, using at least one processor a road dataset and an object dataset including predicted agent trajectories, wherein the at least one processor includes a graphical processing unit (GPU); constructing, using the at least one processor and a graph construction algorithm, as a function of the road dataset and the object dataset, a lattice, wherein the lattice includes: a plurality of vertices each vertex representing a kinematic pose defined by at least a position, an orientation, and a curvature at a lateral offset from a reference path; and a plurality of edges connecting at least a portion of the plurality of vertices, wherein each edge of the plurality of edges includes a kinematically feasible trajectory between kinematic poses; and determining costs, using the at least one processor, for one or more of the plurality of vertices and the plurality of edges, wherein determining the costs includes: a first stage including a plurality of edge cost operations executed in parallel across all of the plurality of edges of the lattice, wherein each GPU thread is assigned to one edge and is configured to compute a plurality of heterogeneous costs for that edge; and a second stage including a path cost computation executed cooperatively within GPU thread blocks; and determining, using the at least one processor, an optimal path as a function of the costs of the one or more of the plurality of vertices and the plurality of edges and a pathfinding algorithm.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 shows an exemplary embodiment of a system for GPU-accelerated cost calculation;

FIG. 2 shows an exemplary embodiment of a GPU cost calculator;

FIG. 3 shows an exemplary lattice;

FIG. 4 shows another exemplary lattice;

FIGS. 5A and 5B shows an exemplary vehicle computing architecture;

FIG. 6 shows an exemplary machine-learning module;

FIG. 7 shows an exemplary neural network;

FIG. 8 shows a flow diagram of a method for GPU-accelerated cost calculation; and

FIG. 9 shows an exemplary diagrammatic representation of one embodiment of a computing device in the exemplary form of a computer system.

### DETAILED DESCRIPTION

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

As used herein, the term “ratio” refers to a relationship between two numbers (e.g., scores, summations, and the like). Although, ratios can be expressed in a particular order (e.g., a to b or a:b), one of ordinary skill in the art will recognize that the underlying relationship between the numbers can be expressed in any order without losing the significance of the underlying relationship, although observation and correlation of trends based on the ration may need to be reversed. For example, if the values of a over time are (4, 10) and the values of b over time are (2, 4), the ratio a:b will equal (2, 2.5), while the ratio b:a will be (0.5, 0.4). Although the values of a and b are the same in both ratios, the ratios a:b and b:a are inverse and increase and decrease, respectively, over the time period.

### DETAILED DESCRIPTION

### System for GPU-Accelerated Cost Calculation

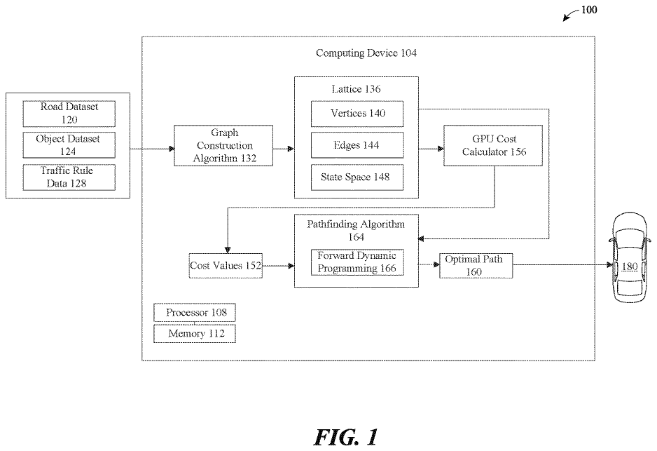

Referring now to FIG. 1, an exemplary embodiment of system 100 for GPU-accelerated cost calculation is illustrated. System 100 may include circuitry such as without limitation a processor communicatively connected to a memory; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 104 includes at least one processor 108. Computing device 104 includes a memory 112. Memory 112 is communicatively connected to the at least one processor 108. Memory 112 may contain instructions configuring the at least one processor 108 to perform one or more actions as described throughout this disclosure.

With continued reference to FIG. 1, memory 112 may include instructions configuring processor 108 to receive data from a world model. memory 112 may include instructions configuring processor 108 to receive data from one or more data sources. One or more data sources may include encodings of objects (e.g., vehicles, agents, auxiliary features, and pedestrians), properties (e.g., position, speed, velocity acceleration, distance, and direction), relationships, hidden variables (e.g., latent state), and the like. One or more data sources may be constructed from real-world data. In some embodiments, one or more data sources may include or be constructed from fused data from sensors (as a non-limiting example, camera pictures may be “overlayed” with depth data from LIDAR using, as a non-limiting example, machine vision or feature recognition).

With continued reference to FIG. 1, one or more data sources may include a road dataset 120. Road dataset 120 may include road data. Road dataset 120 may include geographic locations of roads. Road dataset 120 may include intersections between roads. Road dataset 120 may include data from geospatial (GIS) files. In some embodiments, memory 112 may include instructions configuring processor 108 to receive road dataset 120 from one or more data sources. Road dataset 120 may include map data that has been cropped and transformed to the local frame (e.g., HD map).

With continued reference to FIG. 1, memory 112 may include instructions configuring processor 108 to receive an object dataset 124 from one or more data sources. Object dataset 124 may include data including one or more objects in the one or more data sources. Objects may include cars, agents, pedestrians, signs, obstacles, and the like. Objects may include, for example, objects for an autonomous vehicle to avoid. In some embodiments, objects in object dataset may include location data, wherein the location data provides the location of the object in the world. Location data may include, as non-limiting examples, latitude, longitude, geographical coordinates, GPS coordinates, relative coordinates, or mailing addresses. Object dataset 124 may include predicted agent trajectories rasterized into grids (e.g., agent_score_grid+min_agent_score_grid). Agents may include other cars, moving objects, or people, as non-limiting examples. In some embodiments, object dataset 124 may include distances to static obstacles from perception sensors. Static obstacles may include, as nonlimiting examples, potholes, disabled cars, closed lanes, parked cars, and the like. In some embodiments, memory 112 may include instructions configuring processor 108 to receive data including, but not limited to maneuvers, scheduled_part, direction_map, driving_mode, anchor_points.

With continued reference to FIG. 1, processor 108 may be configured to determine an agent occupancy grid, wherein determining the agent occupancy grid may include resampling each predicted trajectory to a uniform temporal resolution, wherein the predicted agent trajectories comprise agent states at temporal points, at least a position, an orientation, and a polygonal footprint. Determining the agent occupancy grid may further include, for each temporal point, using the graphical processing unit, rasterizing the polygonal footprints associated with that temporal point into a two-dimensional distance grid, wherein determining the optimal path as a function of the costs of the one or more of the plurality of vertices and the plurality of edges and the pathfinding algorithm comprises determining the optimal path as a function of the two-dimensional distance grids.

With continued reference to FIG. 1, memory 112 may include instructions configuring processor 108 to receive, from the one or more data sources, a traffic rule data 128. Traffic rule data 128 may include traffic rules. Traffic rules may include, as non-limiting examples, speed limits, speed minimums, lane change constraints, lane use restrictions, tolls, traffic patterns, turning lanes, parking rules, and the like. Traffic rules may be received from a GIS model. In some embodiments, traffic rule data 128 may be received as a component of road dataset 120. For example, in some embodiments, traffic rule data 128 may be a subcomponent of road dataset 120. In some embodiments, traffic rule data 128 may be received from HD_Map. Traffic rule data 128 may include, as non-limiting examples, speed limits via KinematicLimitsParameters, kinematic constraints from EdgeStates, restricted zones, anmeuver parameters (lane change restrictions), or avoid_area cost (restricted zones).

With continued reference to FIG. 1, in some embodiments, one or more data sources may include a predicted trajectories for agents. An agent is an object or vehicle, other than the autonomous vehicle that is being controlled, which is tracked by the autonomous vehicle. Agents may include, as non-limiting examples, moving objects, such as other vehicles, cars, robots, pedestrians, or the like. Agents may include objects detected by the autonomous vehicle, such as signs, cones, barriers, and the like.

With continued reference to FIG. 1, in some embodiments, generation of plurality of projected trajectories may include using a feature extraction backbone. In some embodiments, a feature extraction backbone may be used to extract features from real-world data such as telemetry dataset and/or position dataset. In some embodiments, features may be shared features that may be used on each head of a multi-task machine-learning model. Feature extraction backbone may be a shared feature-extraction backbone that is used by each head of the multi-task machine learning model. Feature extraction backbone may include a feature extractor; feature extractor may include a convolutional neural network (CNN), deep neural network (DNN), a vision transformer (ViT), resnet, multimodal feature extractors, or the like. In some embodiments, feature extraction backbone may extract features from telemetry dataset and/or position dataset and feed them to trajectory projection algorithm as input.

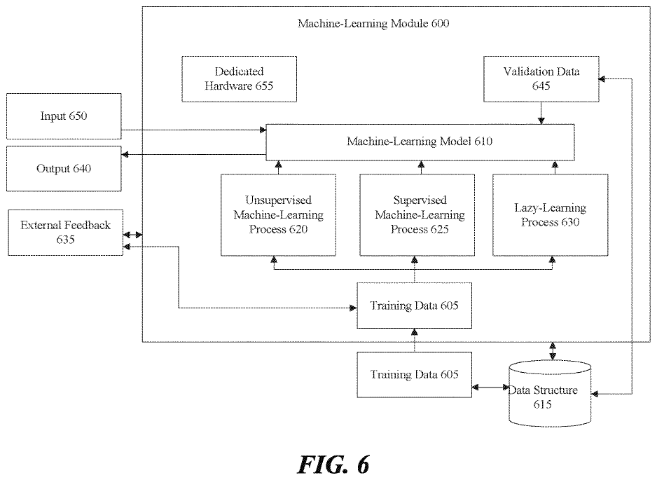

With continued reference to FIG. 1, trajectory projection algorithm may include a trajectory prediction machine-learning model. Trajectory prediction machine-learning model may be configured to receive agent data as input and out a projected trajectory. In some embodiments, agent data may include telemetry dataset and/or position dataset. In some embodiments, trajectory prediction machine-learning model may be trained using trajectory prediction training data. In some embodiments trajectory prediction training data may include real-world data (such as collected telemetry and position data) correlated to ground truth trajectories. In some embodiments, trajectory prediction training data may include previously collected data, such as data collected using vehicle sensor sets in the past. As such, vehicle sensor sets and data processing algorithms may collect the real (i.e. ground truth) trajectories of agents, from which trajectory prediction machine-learning model may be trained. Trajectory prediction machine-learning model may be configured to output with plurality of projected trajectories, points along the trajectory (e.g., plurality of trajectory points), and probabilities associated with those points. Trajectory prediction machine-learning model may be trained using machine-learning module 600, discussed with reference to FIG. 6.

In some embodiments, plurality of projected trajectories each may include a plurality of trajectory points associated with probabilities. For example, trajectory points may indicate points on the trajectory that the agent is projected to transit through. Probabilities may indicate a probability that an agent will occupy that space or point. In some embodiments, plurality of projected trajectories may include temporal data regarding the trajectories. For example, each trajectory point may be associated with a temporal point indicating the time at which an agent is predicted to be at the trajectory point.

With continued reference to FIG. 1, in some embodiments, memory 112 may include instructions configuring processor 108 to receive congestion dataset one or more datasets. Congestion dataset may include data comprising historical traffic data and/or historical congestion data. Congestion dataset may include the projected locations of other autonomous vehicles. Congestion dataset may include the current locations of other autonomous vehicles. In some embodiments, congestion dataset may be part of road dataset 120 or parameters of HD_Map.

With continued reference to FIG. 1, memory 112 may include instructions configuring processor 108 to construct, using a graph construction algorithm 132, a lattice 136. In some embodiments, memory 112 may include instructions configuring processor 108 to construct, using a graph construction algorithm 132, as a function of the road dataset 120 and the object dataset 124, lattice 136. In some embodiments, memory 112 may include instructions configuring processor 108 to construct, using a graph construction algorithm 132, as a function of the road dataset 124, object dataset 124, and traffic rule data 128, lattice 136. In some embodiments, memory 112 may include instructions configuring processor 108 to construct, using a graph construction algorithm 132, as a function of the road dataset 124, object dataset 120, object dataset 124, congestion dataset, agent data, and/or trajectory data, lattice 136.

With continued reference to FIG. 1, in some embodiments, graph construction algorithm 132 may generate vertices 140 along traversable paths for the autonomous vehicle. For example, graph construction algorithm 132 may generate vertices 140 along roads, paths, lanes, and the like. In some embodiments, graph construction algorithm 132 may generate vertices 140 at the intersection of one or more roads or paths. In some embodiments, where lane level precision is required, graph construction algorithm 132 generate vertices 140 along each lane and connect the vertices 140 in a lane, with edges 144. Graph construction algorithm 132 may be configured to connect vertices 140 with edges 144 in accordance with traffic rules and road layouts. Vertices 140 represent kinematic poses at lateral offsets along the reference path. Edges 144 represent smooth trajectories between poses. For example, an edge may represent a trajectory between a first kinematic pose (vertex 1) and a second kinematic pose (vertex 2).

With continued reference to FIG. 1, graph construction algorithm 132 may generate one or more milestones may be placed along a reference path. Along the reference path transverse cross-sections called milestones may be placed. The spacing may depend on speed. As a non-limiting example, step=clamp (speed×0.5 s, 1.5 m, 8.0 m), where speed increases at 1.8 m/s² between milestones. A total of 16 milestones may be used. As a nonlimiting example, 1 for the ego position+15 generated. At low speed, milestones may cluster near the vehicle (~1.5 m apart); at higher speeds, they may spread out (up to 8 m).

With continued reference to FIG. 1, graph construction algorithm 132 may generate one or more vertices using the milestones. At each milestone, up to 11 base nodes may be generated with uniform lateral offsets across the allowable corridor perpendicular to the lane, plus up to 3 nodes from the previous trajectory. Each node may be a full kinematic pose (x, y, yaw, curvature, curvature_derivative) at a specific lateral shift from the lane center. The ego milestone (milestone 0) may have 1 node—the current vehicle position. In some embodiments, ego nodes may include different curvatures when the vehicle is stationary, adding a penalty for steering in place. In this case, all ego nodes may share the same x, y, yaw but may differ in curvature. Thus the ego milestone is not inherently limited to a single node.

With continued reference to FIG. 1, for graph construction algorithm 132, edges may connect nodes across any pair of milestones where the source milestone has a lower index than the target milestone—not just adjacent milestones. The edge builder may iterate over all pairs (i, j) where i<j. Each edge, in embodiments, is not an abstract link but rather a kinematically feasible trajectory (a polyline of intermediate poses), which may be generated via 3rd-5th degree polynomial curve fitting, respecting curvature constraints. Edge geometry generation may be run on either CPU or GPU.

With continued reference to FIG. 1, for graph construction algorithm 132, for each milestone, the intersection with the kinematic reachability envelope may be computed (left/right limiting trajectories based on kinematic limits—including, as examples, maximum steering rate, normal acceleration, normal jerk constraints, steering acceleration, and curvature limit). Nodes beyond the reachable set may be marked as Adjusted (clipped).

With continued reference to FIG. 1, for graph construction algorithm 132, milestones may be shared across all maneuver variants. Each maneuver (path) may generate its own nodes at each milestone based on its reference path. An EdgePathFilter may track which edges belong to which path.

With continued reference to FIG. 1, lattice 136 may include vertices 140 and edges 144. In some embodiments, lattice 136 may include state spaces 148. A “state space,” for the purposes of this disclosure, is all possible states that an autonomous vehicle could occupy in a lattice. States, in this context, may include speed, location, and/or orientation. States may include milestone_idx (longitudinal position along the reference path) which may have 16 values. States may include node_idx (lateral offset within the milestone cross-section) which may have up to 14 per milestone per path. States may include speed_idx (discretized speed) which may have 25 levels. Each state may be defined by the tuple (milestone, lateral_node, speed_index), yielding ~16×14×25≈5,600 states per path. Each node may also carries a full kinematic pose (x, y, yaw, curvature, curvature_derivative). Speed may be discretized via SpeedIndex: the range [0, max_speed] is divided into 25 uniform levels: speed[i]=i×(max_speed/24). Paths may be traversable by an autonomous vehicle.

With continued reference to FIG. 1, graph construction algorithm 132 may assign one or more costs to vertices 140 and/or edges 144. Costs may be related to, as non-limiting examples, a transit time over that segment of the map, a projected congestion, a current congestion, a speed limit or a bottleneck.

With continued reference to FIG. 1, memory 112 may include instructions configuring processor 108 to calculate cost values 152 for lattice 136 using a graphical processing unit (GPU) cost calculator 156. GPU cost calculator 156 may be configured to calculate cost values for use with lattice 136. GPU cost calculator 156 may make use of GPU acceleration to perform the calculations of cost values 152. GPU acceleration is the use of a GPU to perform computation faster than using a traditional central processing unit (CPU) by processing many operations in parallel.

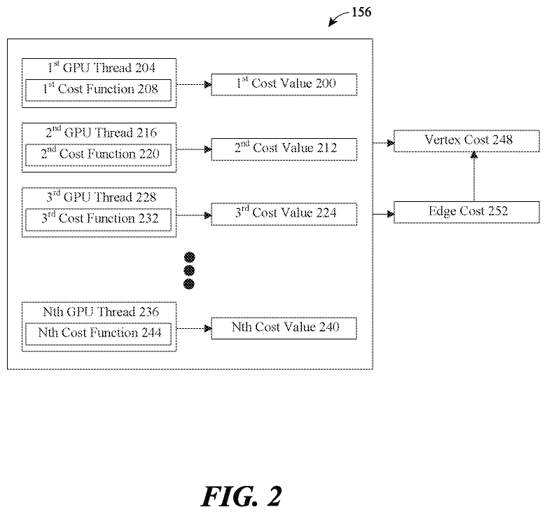

Referring now to FIG. 2, an exemplary embodiment of a GPU cost calculator 156 is shown. GPU cost calculator 156 may be configured to calculating a first cost value 200 using a first graphical processing unit thread 204. For the purposes of this disclosure, a “GPU thread” is the smallest unit of programmable execution in a GPU. The plurality of threads of a GPU enable a GPU to perform numerical calculations in parallel therefore speeding up the time that it takes to process the numerical calculations.

With continued reference to FIG. 2, in some embodiments, software may be used to configure the GPU to perform the one or more calculations in parallel. As non-limiting examples, CUDA, OpenCL, tensor flow, and/or pytorch may be used to enable parallel execution.

With continued reference to FIG. 2, a GPU may have a plurality of threads. A GPU may have 1,000 to 100,000 threads. GPU may have 10,000 threads. Unlike a CPU, which may only have a few cores designed for sequential processing, a GPU may be built for massively parallel computation. Modern GPUs may contain many smaller processing units (often called cores or stream processors) that can execute many lightweight threads simultaneously. These threads may be organized and executed in groups. For example, GPUs may execute threads in groups. These groups may be referred to as, as non-limiting examples, warps or wavefronts. In some embodiments, each group may have 32 threads. In some embodiments, each group may have 64 threads. A single GPU multiprocessor may run many of these groups concurrently, allowing thousands of threads to be active at the same time. The GPU may schedule and run them in batches depending on available hardware resources.

With continued reference to FIG. 2, in some embodiments, threads may be arranged into thread blocks. Thread blocks may be groups of threads that share fast local memory. A grid may include a collection of thread blocks wherein the grid is configured to execute a GPU program.

With continued reference to FIG. 2, in some embodiments, a first cost function 208 may be used to calculate first cost value 200 using thread 204. A cost function quantifies the cost associated with an element of lattice 136. The cost is a measure of the benefits or cost associated with a solution. For example, pathfinding algorithms may be configured to determine a route with the lowest cost (e.g., calculated by summing the costs of the lattice 136 elements traversed as part of the route.)

With continued reference to FIG. 2, in some embodiments, GPU cost calculator 156 may be configured to calculate a second cost value 212 using a second graphical processing unit thread 216. In some embodiments, GPU cost calculator 156 may be configured to calculate a second cost function 220 to determine second cost value 212. In some embodiments, GPU cost calculator 156 may be configured to calculate a third cost value 224 using a third graphical processing unit thread 228. In some embodiments, GPU cost calculator 156 may be configured to calculate a third cost function 232 to determine third cost value 224.

With continued reference to FIG. 2, first cost value 200, second cost value 212, and third cost value 224 may be any appropriate types of cost. Cost may include, as non-limiting examples, kinematic costs, lane positioning costs, obstacle margin costs, or temporal costs. Kinematic costs may include, as non-limiting examples, normal acceleration cost, normal jerk cost (normal jerk is the derivative of normal acceleration), curvature cost, a cost associated with rate of curvature change, and/or a curvature acceleration cost. A curvature cost may include a cost associated with the curvature of a path. Lane positioning costs may include, as non-limiting examples, an out of bounds cost, a time lane departure cost (Time-weighted lateral departure from lane), a shift lane departure cost (Lane-shift cost (smoothstep −2x\hat{ }3+3x\hat{ }2)), a distance to reference cost (Distance from reference path), a ML-based stopping lateral deviation cost, an oncoming lane cost (Binary cost for oncoming lane intrusion), and/or an avoid area cost (Cost for entering restricted zones). Obstacle margin costs may include, as non-limiting examples, a static margin cost (Proximity to static obstacles (curbs, walls), e.g. via 4 distance-grid lookups), a stationary margin cost (Proximity to stationary agents (parked cars)), a dynamic margin cost (Proximity to moving agents (pedestrians, vehicles)), a dynamic margin delayed cost (Windowed max of dynamic_margin (conservative lookahead safety)), a static execution inaccuracy cost (Static obstacle margin accounting for vehicle tracking error), and/or a dynamic execution inaccuracy cost (Dynamic obstacle margin accounting for vehicle tracking error) . . . . An object proximity cost may include a cost associated with the proximity of objects relative to the path. Temporal costs may include, as non-limiting examples, a time cost (Edge traversal time: edge.length/avg_speed) and/or an early stopping cost.

With continued reference to FIG. 2, obstacle margin costs may all rely on 2D occupancy/distance grids. TDistanceGrid<float>: Wraps a fastgrid::CF32Grid (2D float array) with a pose-based origin. Each cell stores a scalar value (distance or cost metric). TGridDistanceChecker: Wraps a single grid—transforms world coordinates to grid coordinates, performs integer cell lookup. TMultiGridDistanceChecker<N>: An array of N grids (template parameter). For static collision checking, 4 grids may be used: high static, low static, road border, RC polygon. Vehicle shape decomposition: The vehicle footprint is approximated by a set of circles (CircleDecompositionShape). Grid values may be queried at each circle center, and the maximum is taken. Temporal Grid (AgentGrid): An array of S grids, one per time slice. Used for dynamic margin—for each edge pose, the cost may be evaluated against the time-appropriate grid slice.

With continued reference to FIG. 2, while thread 204, thread 216, and thread 228 are specifically discussed above, GPUs frequently have thousands or tens of thousands of threads. Therefore, a person of ordinary skill in the art, after having reviewed the entirety of this disclosure would appreciate that thread 204, thread 216, and thread 228 are merely exemplary. For example, an Nth GPU thread 236 may be configured to generate an Nth cost value 240 using an Nth cost function 244. In some embodiments, cost values may be processed in parallel using different GPU threads.

With continued reference to FIG. 2, in some embodiments, GPU cost calculator 156 may be configured to determine vertex costs 248 and edge costs 252 in parallel. In some embodiments, GPU cost calculator 156 may be configured to calculate costs for each vertex and edge in lattice 136 in parallel.

With continued reference to FIG. 2, GPU cost calculator 156 may include a first stage including edge cost calculation. In some embodiments, all edge calculations may be run in parallel for all lattice edges. As a non-limiting example, an edge stat operation may be run in parallel across all edges, wherein it calculates cached polynomial coefficients (NA, NJ, CR, CA), curvature penalties, and/or speed limits. As a non-limiting example, an edge stat operation may be run in parallel across all edges, wherein it calculates out-of-bounds costs and filters edges that are out of bounds. As a non-limiting example, a lane departure operation may be run in parallel across all edges where it may calculate Lane departure costs (timed/shift/oncoming/avoid_area). As a non-limiting example, a static distance check operation may be run in parallel across all edges where it may calculate static margin via distance grid lookups. As a non-limiting example, a stationary distance check operation may be run in parallel across all edges where it may calculate stationary margins. As a non-limiting example, a static execution inaccuracy operation may be run in parallel across all edges where it may calculate static execution inaccuracy. As a non-limiting example, a dynamic execution inaccuracy operation may be run in parallel across all edges where it may calculate dynamic execution inaccuracy. In some embodiments, seven operations (such as the ones above) may be run in parallel across all edges. In some embodiments, seven separate CUDA operations run in parallel across all graph edges via cuda::ForEachParallel:—Grid: [num_edges/64] blocks×64 threads/block—Each thread=one edge.

With continued reference to FIG. 2, GPU cost calculator 156 may include a second stage including path cost calculation. In some embodiments, The main kernel for path cost computation may use a two-dimensional block structure; for example, —Grid: dim3(num_runs)—one block per (target node, path) pair—Block: dim3(kMaxTargetSpeedsPerRun, kSourceNodesPerBlock)—speed indices×source nodes. Kernel execution may include, first, cooperative dynamic margin computation. This may include jointly, for all threads in a block, computing CalcPoseDynamicMarginCost for up to 128 poses per edge, and writing results to shared memory (e.g., up to 96 KB). Second, memory may be synchronized between threads to ensure shared memory is populated. Third, each speed-thread may compute a path cost, iterating over reachable source speeds. Fourth, a function may aggregate results across source nodes to find the best cost. In some embodiments, various CUDA constructs may be used; as non-limiting examples, CUDA constructs used: Raw CUDA—runtime_api.h, device_launch_parameters.h, _global_kernels: PathCostImpl, MapKernel, ForEachKernel, _device_functions: ComputePathCost, _grid_constant_(CUDA 12+)—read-only parameters in constant memory, Shared memory (extern__shared_)—for NodeCostInfo and PoseDynamicMarginCost array, cudaStream_t—all operations are stream-ordered. In some embodiments, wherein the second stage may further comprises jointly computing, using threads within a GPU thread block, a dynamic agent margin cost for each of a plurality of sample poses along candidate edges; storing the dynamic agent margin costs in thread-block shared memory; and independently computing, by each thread within the GPU thread block, a path cost for a discretized speed index, as a function of the dynamic agent margin costs from the thread-block shared memory and the edge costs from the first stage.

With continued reference to FIGS. 1 and 2, various non-limiting examples of system 100 are described in this paragraph. For example, system for GPU-accelerated trajectory cost evaluation in autonomous vehicle motion planning, the system comprising: at least one processor comprising a graphical processing unit (GPU); ca memory communicatively connected to the at least one processor and containing instructions configuring the at least one processor to: (a) receive a road dataset, an object dataset comprising predicted agent trajectories, and a set of distance grids comprising at least a static obstacle distance grid and a temporal agent distance grid, wherein the temporal agent distance grid comprises a plurality of time-sliced two-dimensional grid layers spanning a planning horizon, each grid layer encoding a distance-based collision score for predicted agent positions within a respective time interval of the planning horizon; (b) construct, using a graph construction algorithm and as a function of the road dataset and the object dataset, a lattice comprising: —a plurality of vertices, each vertex representing a kinematic pose defined by at least a position, an orientation, and a curvature at a lateral offset from a reference path; and —a plurality of edges connecting vertices across longitudinal milestones along the reference path, each edge representing a kinematically feasible trajectory between kinematic poses; (c) determine costs for the plurality of edges using a two-stage GPU-parallel computation comprising: a first stage comprising a plurality of edge cost operations executed in parallel across all edges of the lattice, wherein each GPU thread is assigned to one edge and computes a plurality of heterogeneous cost components for that edge, the cost components comprising at least: —a kinematic cost derived from curvature, normal acceleration, and normal jerk along the edge trajectory; —a lane positioning cost derived from lateral departure from the reference path; and —an obstacle margin cost derived from querying the static obstacle distance grid at a plurality of sample points along the edge, wherein each sample point is evaluated using a vehicle shape decomposed into a set of circles, and a grid value is queriedcat each circle center; a second stage comprising a path cost computation executed cooperatively within GPU thread blocks, wherein: —each thread block corresponds to a target vertex and a candidate path; —threads within the thread block jointly compute a dynamic agent margin cost for each of a plurality of sample poses along candidate edges by indexing into the temporal agent distance grid at the time-sliced layer corresponding to an estimated arrival time at each sample pose, and storing the computed per-pose dynamic margin costs in thread-block shared memory; —after a thread synchronization barrier, each thread independently computes a path cost for a respective discretized speed index by reading the per-pose dynamic margin costs from shared memory and aggregating edge costs from the first stage; and the thread block determines a minimum-cost path to the target vertex by aggregating results across source vertices; (d) determine an optimal trajectory through the lattice as a function of the computed costs using a forward dynamic programming sweep over the lattice vertices ordered by milestone index and discretized speed; and (e) configure an autonomous vehicle to execute the optimal trajectory. As another example, a method for constructing a temporal agent distance grid for use in autonomous vehicle motion planning, the method comprising: receiving, using at least one processor, a plurality of predicted agent trajectories, each trajectory comprising a sequence of time-stamped agent states including at least a position, an orientation, and a polygonal footprint; resampling each predicted trajectory to a uniform temporal resolution over a planning horizon; for each of a plurality of time slices spanning a configurable planning horizon, rasterizing, using a GPU, the predicted agent footprints present in that time slice into a two-dimensional distance grid by: —for each grid cell, transforming the cell position into the local coordinate frame of each agent at each trajectory frame within the time slice using a precomputed inverse transform matrix; —computing a signed distance from the transformed cell position to the agent's polygonal footprint; —converting the signed distance into a margin-based collision score using a margin function that maps distances to cost values based on configurable safety buffer thresholds; and —storing the maximum collision score across all agents and frames as the cell value; computing a minimum-over-time grid by, for each grid cell, taking the minimum collision score across all time slices, the minimum-over-time grid representing a conservative worst-case dynamic obstacle proximity at each spatial location; storing the plurality of time-sliced grids and the minimum-over-time grid for consumption by a trajectory cost evaluation process. As another example, system 100, wherein the first stage comprises a plurality of distinct edge cost operations dispatched as parallel GPU kernels, each kernel launched with a grid configuration of ┌N/T┐ blocks and T threads per block, where N is the number of lattice edges, and each thread computes one or more cost components for a single edge. As another example, system 100, wherein determining the obstacle margin cost comprises querying a plurality of distance grids including a high-obstacle grid, a low-obstacle grid, a road border grid, and a restricted-zone polygon grid, and taking a maximum cost value across the plurality of grids for each sample point. As another example, system 100, wherein the dynamic agent margin cost further comprises: —a delayed dynamic margin cost computed as a windowed maximum of the dynamic margin score over a configurable time window surrounding the estimated arrival time at each pose; and —a dynamic execution inaccuracy cost accounting for vehicle tracking error by evaluating the temporal agent distance grid with an enlarged vehicle footprint. As another example, system 100, wherein the temporal agent distance grid comprises a plurality of time-sliced layers spanning a configurable planning horizon (e.g., approximately four seconds), with each layer covering a respective temporal interval, and wherein the minimum-over-time grid is computed as a per-cell minimum across all time-sliced layers. As another example, system 100, wherein the forward dynamic programming sweep processes all vertices in milestone order without a priority queue, and for each target vertex and speed index, evaluates all reachable source vertices from all preceding milestones and selects the source state yielding the minimum cumulative cost. The exemplary method described above, wherein the rasterization is organized into spatial tiles, and each GPU thread processes one grid cell by iterating over agent tasks associated with its tile via a precomputed tile index.

With continued reference to FIGS. 1 and 2, two-stage GPU pipeline may include, as a non-limiting examples, Stage 1: dispatches N heterogeneous edge-cost operations in parallel (each thread=one edge), followed by Stage 2: uses cooperative thread-block computation with shared memory for dynamic margin, using a 2D block structure (speed indices×source nodes). The plurality of heterogeneous costs of the first stage may comprises an obstacle margin cost derived from querying the static obstacle distance grid at a plurality of sample points along an edge of the static obstacle distance grid. In some embodiments, wherein querying the static obstacle distance grid at the plurality of sample points comprises evaluating each sample point of the plurality of sample points using a vehicle shape decomposed into a set of circles, wherein each grid value is queried at each circle center.

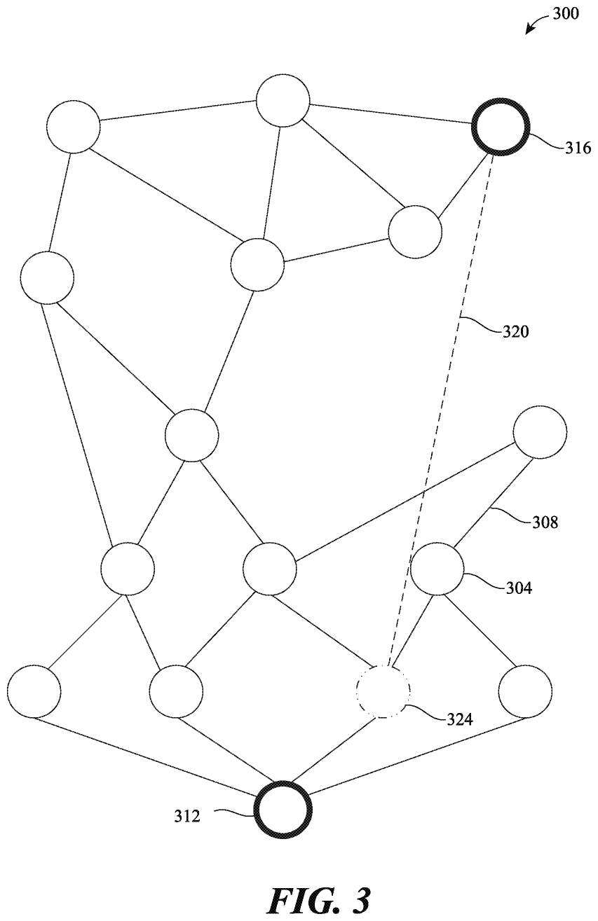

Referring back to FIG. 1, memory 112 may include instructions configuring processor 108 to determine an optimal path 160 as a function of the cost value 152 of the one or more of the plurality of vertices and the plurality of edges and a pathfinding algorithm 164. Pathfinding algorithm 164 may be further described with reference to FIG. 3. In some embodiments, pathfinding algorithm 164 may include forward dynamic programming 166.

With continued reference to FIG. 1, lattice 136 may include a directed acyclic graph (DAG) with strictly increasing milestone indices (source_milestone<target_milestone for all edges), non-negative costs, and a 3D state space of (milestone, lateral_node, speed_index). Given these properties, there are pathfinding algorithms 164 correct results (as non-limiting examples): Forward dynamic programming sweep [this may process milestones in topological order, relaxing each target state from all prior source states. Forward dynamic programming sweep may include optimal and O(V+E). Forward dynamic programming sweep may have the best theoretical complexity for DAGs], Dijkstra's algorithm [may be less efficient than forward DP (O((V+E) log V) due to priority queue], A* search using an admissible heuristic [this can be used on lattice 136 with a suitable heuristic (e.g., minimum remaining time based on max speed and remaining distance). It prune some states but unlikely to help much on this dense DAG where most states are visited anyway], backward dynamic programming (cost-to-go) [same complexity as forward DP, sweeps milestones in reverse. Useful in combination with forward DP for bidirectional pruning], and beam search [this may include an approximate method that retains only the top-k candidate states at each milestone. It may trade optimality for reduced computation; relevant under hard real-time budgets]. For example, in some embodiments, pathfinding algorithm 164 may include at least one of: a forward dynamic programming sweep, a backward dynamic programming sweep, Dijkstra's algorithm, an A* search with an admissible cost heuristic, or a beam search.

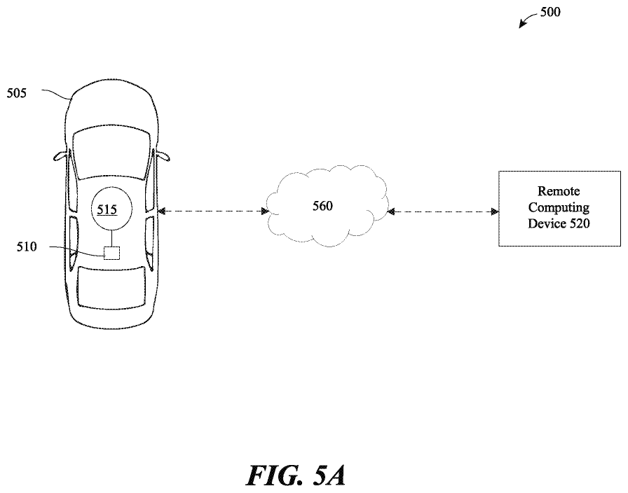

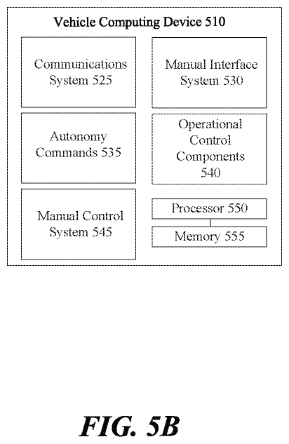

With continued reference to FIG. 1, memory 112 may include instructions configuring processor 108 to configure an autonomous vehicle 180 to execute the optimal path 160. In some embodiments, autonomous vehicle 180 may include an autonomous car. In some embodiments, autonomous vehicle 180 may include a delivery robot. In some embodiments, optimal path 160 may be calculated offboard autonomous vehicle 180; then, optimal path 160, once it has been calculated, may be transmitted to autonomous vehicle 180. In some embodiments, optimal path 160 may be calculated on board autonomous vehicle 180 using, for example, an onboard processor or GPU. In some embodiments, computing device 104 may be located off board of autonomous vehicle 180. In some embodiments, computing device 104 may be located on board of autonomous vehicle 180. An exemplary computing architecture for autonomous vehicle 180 may be further discussed with reference to FIGS. 5A and 5B.

### Exemplary Lattice and Pathfinding Algorithms

Referring now to FIG. 3, a lattice 300 is shown. Lattice 300 may be consistent with lattice 136 described further with reference to FIG. 1. For example, lattice 300 may include a plurality of vertices 304. Vertices 304 may represent kinematic poses at lateral offsets along the reference path. Lattice 300 may include a plurality of edges 308. Plurality of edges 308 may connect plurality of vertices 304 together. Plurality of edges 308 may represent smooth trajectories between poses (verticies). For example, an edge 308 connecting a first vertex to a second vertex may represent a path between two kinematic poses. Thus, in the lattice 300 context, each edge 308 is a pathway that a vehicle could take in between plurality of vertices 304.

With continued reference to FIG. 3, to generate a route, memory may include instructions configuring processor to use a pathfinding algorithm. A pathfinding algorithm systematically explores connections (i.e. edges) between nodes to find information, uncover patterns, and/or determine optimal paths. For example, pathfinding algorithm may be configured to traverse the edges and vertices to find an optimal or otherwise desired route between selected vertices. In some embodiments, pathfinding algorithm may be configured to track visited nodes and decide which node to next visit between the unvisited vertices.

With continued reference to FIG. 3, lattice 300 may include a start vertex 312. Start vertex 312 may include a beginning point or a current location for a vehicle for which a trajectory is sought. In some embodiments, lattice 300 may include an end vertex 316. End vertex 316 may include a destination for a vehicle or a next waypoint or stop point. For example, end vertex 316 may include a parking spot or destination for a rider. In some embodiments, map search algorithm may be configured to determine an optimal trajectory between start vertex 312 and end vertex 316.

With continued reference to FIG. 3, in some embodiment pathfinding algorithm may include a forward dynamic programming sweep (e.g., forward dynamic programming 166). Forward dynamic programming sweep may include a forward dynamic programming sweep over lattice 300 with a discretized speed. For each vertex 304, at the target speed, all source vertices from previous milestones are evaluated and the best cost is updated. As compared to other pathfinding algorithms, forward dynamic programming sweep may include no priority queue and/or no heuristic. In some embodiments, for forward dynamic programming sweep to determine a path from start vertex 312 to end vertex 316, it may break the problem up into sub problems. For example, it may designate several milestones and store the solution for those milestones. Forward dynamic programming sweep may include starting at an vertex, moving forward step-by-step through vertices and edges, then, at each step, compute the optimal value based on previously computed states.

With continued reference to FIG. 3, in some embodiments, pathfinding algorithm may include an informed search algorithm. In some embodiments, pathfinding algorithm may include an A* (A-star) search algorithm. A* may improve speed over a standard pathfinding algorithm by, for example, using a heuristic 320 to guide the search. The heuristic 320 may include, for example, a straight line distance to the destination. A* may determine which vertex to progress to based on the formula:

$$f ( n ) = g ( n ) + h ( n )$$

g(n) may represent the cost from a start vertex to vertex n. Vertex n may be current vertex 324. For example, start vertex 312 may include a current position of a vehicle or a start waypoint. Vertex n is the current vertex 324 being evaluated by the algorithm. h(n) may represent an estimated cost, using the heuristic, from vertex n to the goal. Goal may include the destination for a vehicle. Using this function, A* may determined an estimated cost f(n). Then, A* may move to the vertex with the lowest f(n) and repeat this process for vertices adjacent to the new vertex.

With continued reference to FIG. 3, pathfinding algorithm may include a hybrid A* algorithm. A hybrid A* algorithm may be similar to the A* algorithm described above, but hybrid A* algorithm may take into account vehicle motion models. Instead of moving to adjacent vertices, hybrid A* algorithm may simulate small vehicle motions that are actually feasible for a vehicle to perform. These may be done using a kinematic vehicle motion model. This ensures that the vertices evaluated are actually reachable by the vehicle.

With continued reference to FIG. 3, pathfinding algorithm may include Dijkstra's Algorithm. Dijkstra's algorithm may be configured to expand the unvisited vertex with the smallest distance from the current vertex. For each neighbor of the new vertex, the algorithm may determine a distance comprising the current distance added to the edge weight of the vertex. If this determined distance is smaller than the neighbor vertices recorded distance, then the algorithm may record that the best path goes through the current vertex.

With continued reference to FIG. 3, pathfinding algorithm may be configured to generate routes with the shortest distance. Pathfinding algorithm may be configured to generate routes with the shortest travel time. Pathfinding algorithm may be configured to generate routes with the least traffic.

With continued reference to FIG. 3, pathfinding algorithm may include a breadth-first search (BFS). BFS may be configured to explore all vertices at the present depth prior to moving on to the vertices at the next depth level. Extra memory, usually a queue, is needed to keep track of the child vertices that were encountered but not yet explored.

With continued reference to FIG. 3, pathfinding algorithm may include a depth-first search (DFS) algorithm. The DFS algorithm may start at the root vertex (selecting some arbitrary vertex as the root vertex in the case of a graph) and explore as far as possible along each branch before backtracking to investigate other branches. Extra memory, usually a stack, is needed to keep track of the vertices discovered so far along a specified branch which helps in backtracking of the graph.

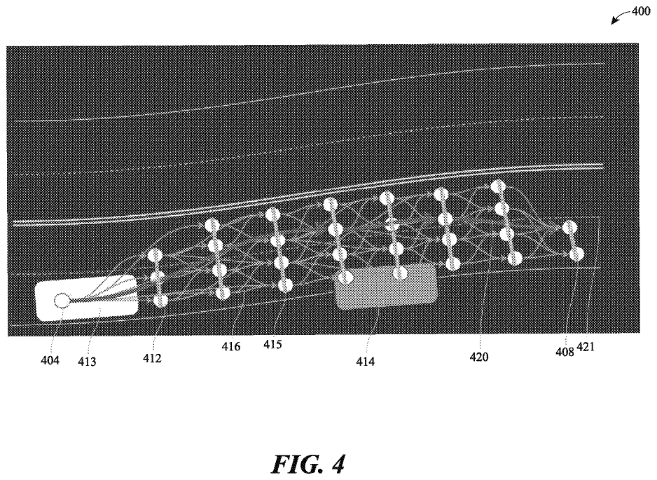

Referring now to FIG. 4, an exemplary lattice 400 is shown. Lattice 400 may include a start vertex 404 and an end vertex 408. Exemplary lattice 400 may include a plurality of vertices 412 and a plurality edges 416 connected the plurality of vertices 412. Plurality of vertices 412 may include discrete vertices positioned along the milestones that represent specific kinematic poses, such as position, orientation, and curvature. Plurality edges 416 may include smooth, kinematically feasible curves that connect nodes across milestones; these represent the paths for which costs are calculated in parallel on the GPU. Lattice 400 may be overlayed or generated from a road layout. Road layout may include a multi-lane environment providing the structural boundaries and traffic direction markers for navigation. Lattice 400 may include an ego vehicle 413. Ego vehicle 413 is the autonomous vehicle being controlled. Ego vehicle 413 may be located at the starting point of the planning cycle. Lattice 400 may include or represent a stationary agent obstacle 414. Stationary agent obstacle 414 may include a parked or stationary vehicle that partially blocks the lane, which may serve as a high-cost area that the planner must navigate around. Lattice 400 may include one or more speed-dependent milestones 415. One or more speed-dependent milestones 415 may include transverse cross-sections placed along the road. In some embodiments, the longitudinal spacing of one or more speed-dependent milestones 415 may be adjusted based on the vehicle's velocity. The display of lattice 400 in FIG. 4 includes an optimal trajectory. Optimal path 420 may represent the sequence of edges with the lowest cumulative cost, for example, successfully bypassing stationary agent obstacle 414. In some embodiments, display of lattice 400 may include a reference path 421. Reference path 421 may function as central guiding line used to align the milestones and establish the target lateral positioning within the lane.

Referring now to FIGS. 1-4, in some aspects, the techniques described herein relate to a system for GPU-accelerated cost calculation, the system including: at least one processor including a graphical processing unit (GPU); and a memory communicatively connected to the at least one processor and containing instructions configuring the at least a processor to: receive a road dataset and an object dataset including predicted agent trajectories; construct, using a graph construction algorithm, as a function of the road dataset and the object dataset, a lattice, wherein the lattice includes: a plurality of vertices each vertex representing a kinematic pose defined by at least a position, an orientation, and a curvature at a lateral offset from a reference path; and a plurality of edges connecting at least a portion of the plurality of vertices, wherein each edge of the plurality of edges includes a kinematically feasible trajectory between kinematic poses; determine costs for one or more of the plurality of vertices and the plurality of edges, wherein determining the costs includes: a first stage including a plurality of edge cost operations executed in parallel across all of the plurality of edges of the lattice, wherein each GPU thread is assigned to one edge and is configured to compute a plurality of heterogeneous costs for that edge; and a second stage including a path cost computation executed cooperatively within GPU thread blocks; and determine an optimal path as a function of the costs of the one or more of the plurality of vertices and the plurality of edges and a pathfinding algorithm.

Referring now to FIGS. 1-4, in some aspects, the techniques described herein relate to a system, wherein the memory contains instructions further configuring the at least a processor to determine an agent distance grid including: resampling each predicted trajectory to a uniform temporal resolution, wherein the predicted agent trajectories include agent states at temporal points, at least a position, an orientation, and a polygonal footprint; and for each temporal point, using the graphical processing unit, rasterizing the polygonal footprints associated with that temporal point into a two-dimensional distance grid, wherein determining the optimal path as a function of the costs of the one or more of the plurality of vertices and the plurality of edges and the pathfinding algorithm includes determining the optimal path as a function of the two-dimensional distance grids.

Referring now to FIGS. 1-4, in some aspects, the techniques described herein relate to a system, wherein the second stage further includes: jointly computing, using threads within a GPU thread block, a dynamic agent margin cost for each of a plurality of sample poses along candidate edges; storing the dynamic agent margin costs in thread-block shared memory; independently computing, by each thread within the GPU thread block, a path cost for a discretized speed index, as a function of the dynamic agent margin costs from the thread-block shared memory and the edge costs from the first stage.

Referring now to FIGS. 1-4, in some aspects, the techniques described herein relate to a system, wherein the plurality of heterogeneous costs of the first stage includes an obstacle margin cost derived from querying a static obstacle distance grid at a plurality of sample points along an edge of the static obstacle distance grid.

Referring now to FIGS. 1-4, in some aspects, the techniques described herein relate to a system, wherein querying the static obstacle distance grid at the plurality of sample points includes evaluating each sample point of the plurality of sample points using a vehicle shape decomposed into a set of circles, wherein each grid value is queried at each circle center.

Referring now to FIGS. 1-4, in some aspects, the techniques described herein relate to a system, wherein: each edge of the plurality of edges represents a smooth trajectory between kinematic poses; and each vertex of the plurality of vertices represents a kinematic pose at lateral offsets along a reference path.

Referring now to FIGS. 1-4, in some aspects, the techniques described herein relate to a system, wherein determining the costs, includes: a first stage including edge cost calculation, wherein all edge cost calculations are run in parallel for all of the plurality of edges; and a second stage including path cost calculation.

Referring now to FIGS. 1-4, in some aspects, the techniques described herein relate to a system, wherein: the memory contains instructions further configuring the at least one processor to receive, a traffic rule data; and constructing the lattice includes constructing, using a graph construction algorithm, a lattice as a function of the road dataset, the object dataset, and the traffic rule data.

Referring now to FIGS. 1-4, in some aspects, the techniques described herein relate to a system, wherein the pathfinding algorithm includes a forward dynamic programming sweep over the lattice vertices ordered by milestone index and discretized speed.

Referring now to FIGS. 1-4, in some aspects, the techniques described herein relate to a system, wherein the memory contains instructions further configuring the at least one processor to configure an autonomous vehicle to execute the optimal path.

### Exemplary Vehicle Computing Architecture

Referring now to FIGS. 5A and 5B, an exemplary vehicle computing architecture 500 is shown. Vehicle computing architecture 500 may include a vehicle 505. A “vehicle,” for the purposes of this disclosure is a device that is designed to transport goods, people, and/or animals. In some embodiments, vehicle 505 may be motorized. As non-limiting examples, vehicle 505 may include a car, a scooter, an ebike, an ATV, a motorcycle, a motorbike, a minibike, a truck, a golf cart, an aircraft, and the like. In some embodiments, vehicle 505 may be human-powered. As non-limiting examples, vehicle 505 may include a bike, a rickshaw, a skateboard, a scooter, or the like.

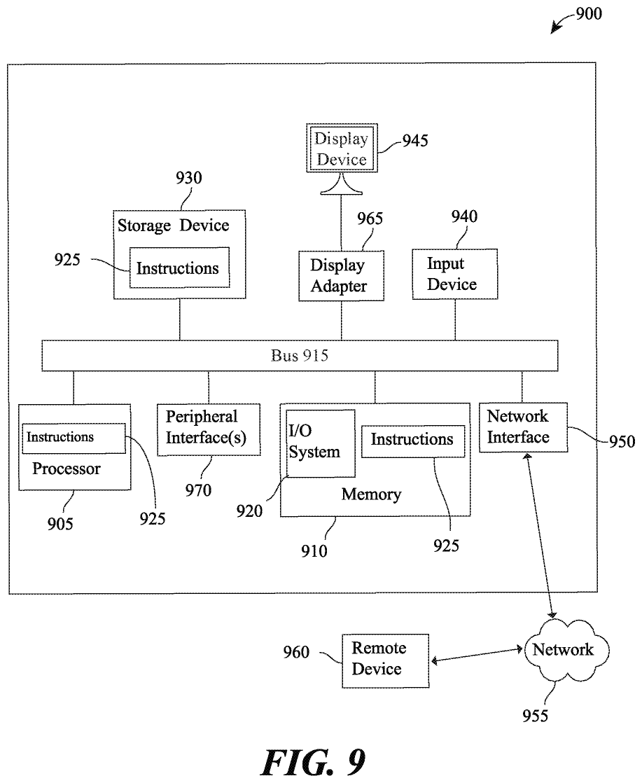

With continued reference to FIGS. 5A AND 5B, the vehicle 505 may be an autonomous vehicle that may drive, navigate, operate, etc. with minimal and/or no interaction from a human driver. Vehicle 505 may include a vehicle computing device 510 that implements a variety of systems on-board the vehicle 505. In some embodiments, vehicle computing device 510 may be consistent with aspects of computing device 900 described further with respect to FIG. 9.

With continued reference to FIGS. 5A and 5B, in some embodiments, vehicle computing architecture 500 may include one or more data acquisition systems 515. A data acquisition systems 515 may include a plurality of sensors configured to detect data from the environment surrounding or inside of vehicle 505. In some embodiments, data acquisition system 515 may include one or more cameras. Cameras may include, as non-limiting examples, wide-angle cameras, high-resolution cameras, panoramic cameras, two-dimensional cameras, three-dimensional cameras, video cameras, and the like. In some embodiments, data acquisition system 515 may include one or more LIDAR sensors. In some embodiments, data acquisition system 515 may include one or more ultrasound sensors. For example, ultrasound sensors may be mounted around the perimeter of vehicle 505. In some embodiments, ultrasound sensors may be located on the corners of vehicle 505. In some embodiments, ultrasound sensors may be used for object detection and/or collision avoidance. In some embodiments, data acquisition system 515 may include one or more microphones. In some embodiments, microphones may be arranged in an array. In some embodiments, microphones may include directional microphones. In some embodiments, microphones may include unidirectional microphones. In some embodiments data acquisition system 515 may include one or more RADAR sensors. In some embodiments, data acquisition system 515 may include, as non-limiting examples, lane detectors, optical readers, electric eyes, and/or other suitable types of image capture devices.

With continued reference to FIGS. 5A and 5B, vehicle computing device 510 may include a plurality of vehicle computing devices 510. As a non-limiting example, in some embodiments, vehicle computing device 510 may include, a central computing device and one or more auxiliary computing devices. In some embodiments, auxiliary computing devices may be located on or in the vehicle 505 roof. In some embodiments, auxiliary computing devices may be located close to certain sensors of data acquisition system 515 that they are configured to process data for. For example, auxiliary computing devices configured to process camera data may be located near cameras. For example, auxiliary computing devices configured to process LIDAR data may be located near LIDAR sensors. This may serve, for example, as an edge computing implementation, wherein, for example, data processing for certain sensors or sources of data may be offloaded to auxiliary computing devices that are closer to the sensors of sources of data of interest. This may beneficially impact data processing as it allows for data to be processed sooner after it is collected.

With continued reference to FIGS. 5A and 5B, the vehicle 505 may be configured to enter into a ready state. The ready state may indicate that the vehicle 505 is ready to operate (and/or return to) an autonomous navigation mode. A computing device on-board the vehicle 505 may be configured to determine whether the vehicle 505 is in the ready state. A remote computing device 520 (e.g., associated with an operations control center) may indicate that the vehicle 505 is ready to begin and/or resume autonomous navigation.

With continued reference to FIGS. 5A and 5B, for instance, the vehicle computing system 510 may include a communications system 525, one or more manual interface systems 530, one or more data acquisition systems 515, an autonomy command 535, one or more operational control components 540, and/or a manual control system 545.

With continued reference to FIGS. 5A and 5B, the manual interface systems 530 may be configured to allow interaction between a user (e.g., human) and the vehicle 505 (e.g., the vehicle computing system 510). The manual interface systems 530 may include a variety of interfaces for the user to input and/or receive information from the vehicle computing system 510. The manual interface systems 530 may include one or more input device(s) (e.g., touchscreens, keypad, touchpad, knobs, buttons, sliders, switches, mouse, gyroscope, microphone, other hardware interfaces) configured to receive user input. The manual interface systems 530 may include a user interface (e.g., graphical user interface, conversational and/or voice interfaces, chatter robot, gesture interface, other interface types) for receiving user input.

With continued reference to FIGS. 5A and 5B, vehicle computing system 510 may include a processor 550 and a memory 555. Processor 550 and memory 555 may be consistent with other processors and memory described throughout this disclosure. Processor 550 and memory 555 may be communicatively connected. Memory 555 may contain instructions (e.g., software) configured to cause processor 550 to perform one or more actions in accordance with this disclosure.

With continued reference to FIGS. 5A and 5B, vehicle computing architecture 500 may include a remote computing device 520. the remote computing device 520 may include and/or otherwise be associated with one or more computing devices (e.g., computing device 900, referred to in FIG. 9) that are remote from the vehicle 505. The remote computing device 520 may communicate with the vehicle 505 via one or more communications networks 560. The communications network 560 may include various wired and/or wireless communication mechanisms (e.g., cellular, wireless, satellite, microwave, and radio frequency) and/or any desired network topology. For example, the communications network 560 may include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 505.

### Exemplary Machine-Learning Module and Neural Network

Referring now to FIG. 6, an exemplary embodiment of a machine-learning module 600 is shown. Machine-learning module 600 may be configured to perform one or more machine learning processes as described throughout this disclosure. Machine-learning module 600 may perform determinations, classification, and/or analysis steps, methods, processes, or the like as described in this disclosure using machine learning processes. A “machine learning process,” as used in this disclosure, is a process that automatedly uses training data 605 to generate one or more machine-learning models 610.

With continued reference to FIG. 6, for the purposes of this disclosure, “training data” is data that contains correlations that a machine-learning process may use to model relationships between two or more types of data. For example, training data 605 may include one or more training examples. Multiple data entries in training data 605 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. In some embodiments, training data 605 may include input training data correlated to output training data. Input training data may include, as a non-limiting example real-world data as described further throughout this disclosure. Output training data may include, as a non-limiting example ground truth trajectories, as described further throughout this disclosure. Elements in training data 605 may be linked to descriptors of categories by tags, tokens, or other data elements; for instance, and without limitation, training data 605 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

With continued reference to FIG. 6, in some embodiments, training data 605 may be divided into different formats, categories, and/or groups. For example, in some embodiments, training data 605 may be divided into one or more cohorts, categorizations, time periods, data sources, and the like. In some embodiments, training data 605 may be assigned to categories using a classifier; as a non-limiting example, a training data classifier. Training data classifier may include a machine-learning module as described elsewhere with respect to FIG. 6. For example, in some embodiments, training data 605 may be input into training data classifier and training data classifier may output a classification. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 600 may generate a classifier using a classification algorithm, defined as a processes whereby a computing device and/or any module and/or component operating thereon derives a classifier from training data 605. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 6, training data 605 may be retrieved, in some embodiments, from a data structure 615. A data structure 615 may be remote to a computing device and communicative with a computing device by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local servers or personal computers. A “mesh network” as used in this disclosure is a local network topology in which the infrastructure a computing device connect directly, dynamically, and non-hierarchically to as many other computing devices as possible. A “network topology” as used in this disclosure is an arrangement of elements of a communication network. data structure 615 may be implemented, without limitation, as a relational database, a key-value retrieval database such as a NOSQL database, or any other format or structure for use as a database that a person skilled in the art would recognize as suitable upon review of the entirety of this disclosure. data structure 615 may alternatively or additionally be implemented using a distributed data storage protocol and/or data structure, such as a distributed hash table or the like. data structure 615 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In an embodiment, data structure 615 may be a generic storage mechanism. A generic storage mechanism may be a storage system or method that is not specific to any particular type or format of data, that is, a storage solution that provides a flexible and adaptable way to store and retrieve data without being tied to a specific data format, schema, or domain. In some embodiments, training data 605 may be stored in data structure 615. In some embodiments, training data 605 may be retrieved from data structure 615.

With continued reference to FIG. 6, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

With continued reference to FIG. 6, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

With continued reference to FIG. 6, a “machine-learning model,” as used in this disclosure, is a data structure representing and/or instantiating a mathematical and/or algorithmic representation of a relationship between inputs and outputs as generated using any machine-learning process. For example, machine-learning process may include, without limitation, any machine-learning process described in this disclosure.

With continued reference to FIG. 6, machine-learning process may include an unsupervised machine-learning process 620. An unsupervised machine-learning process, as used herein, is a process that derives inferences in datasets without regard to labels; as a result, an unsupervised machine-learning process may be free to discover any structure, relationship, and/or correlation provided in the data. Unsupervised processes machine-learning process 620 may not require a response variable; unsupervised processes machine-learning process 620 may be used to find interesting patterns and/or inferences between variables, to determine a degree of correlation between two or more variables, or the like.

With continued reference to FIG. 6, machine-learning process may include a supervised machine-learning process 625. Supervised machine-learning process 625 may use training data 605 with both exemplary inputs and expected outputs and use that training data 605 to train a machine-learning model 610. For example, during a training process, machine learning process may evaluate an actual output generated by machine-learning model 610 and compare it to an expected output from training data 605. Based on the difference between the actual and expected outputs, one or more weights within machine-learning model 610 may be updated. For example, in some cases a scoring function may be used to train machine-learning model 610. Scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 605.

With continued reference to FIG. 6, machine-learning process may include a lazy-learning process 630. Lazy learning is a machine-learning approach in which the model delays generalization until a query is made. For example, this can be rather than learning a global model during training. Instead of building an abstract representation of the data up front, a lazy learner may store the training instances and wait until it needs to make a prediction. For example, when a new input arrives, the system may perform computation on the fly. Because no heavy training occurs in advance, lazy-learning algorithms may be fast to set up but can be computationally expensive at prediction time and often require storing large datasets in memory. An example may include k-nearest neighbors (k-NN), which classifies new points based on the labels of their closest neighbors in the stored data. Lazy learning may adapt naturally to new data because the “model” is effectively the dataset itself, but this also means it can be sensitive to noise and may not scale well with very large datasets.

With continued reference to FIG. 6, in some embodiments, machine-learning module 600 may receive external feedback 635. External feedback 635 may include, as a non-limiting example, feedback received from a user. In some embodiments, external feedback 635 may be received through a user interface (such as, for example, a graphical user interface (GUI).

With continued reference to FIG. 6, machine-learning module 600 may be configured to re-train machine-learning model 610. In some embodiments, re-training machine-learning model 610 may include re-training machine-learning model 610 as a function of external feedback 635. In some embodiments, external feedback 635 may serve as a source of labeled or partially labeled data that reflects how the model performs in real-world conditions. For example, if a user provides negative external feedback 635, then the set of data from training data 605 may be assigned a negative label. In some embodiments, external feedback 635 may include users correcting an output 640 of machine-learning model 610—such as flagging an incorrect prediction, choosing a preferred recommendation, or providing explicit labels. These interactions can be collected and added back into the training dataset. Over time, this additional data may help the model adapt to new patterns, correct systematic errors, and better align with user expectations. The re-training process may include cleaning and validating external feedback 635, merging it with existing datasets such as training data 605, and/or periodically running a new training cycle to update model parameters.

With continued reference to FIG. 6, machine-learning module 600 may be configured to validate machine-learning model 610. In some embodiments, machine-learning module 600 may validate machine-learning model 610 using validation data 645. Validation data 645 may be a subset of data used to train machine-learning model 605. For example, validation data 645 may include a subset of training data 605. In some embodiments, validation data 645 may include a percentage of training data 605. As non-limiting example, validation data 645 may include 1%, 2%, 5%, 10%, 20%, 30%, and the like of training data 605. In some embodiments, machine-learning model 610 may not be exposed to validation data 645 during training. Validation data 645 may acts as a checkpoint that helps determine whether the model is generalizing well or simply memorizing training data 605. As the model learns, its performance on the validation set may be monitored to guide decisions such as choosing hyperparameters, selecting architectures, adjusting regularization strength, or determining when to stop training to avoid overfitting.

With continued reference to FIG. 6, machine-learning model 610 may be configured to receive one or more inputs 650 and generate, as a function of the one or more inputs 650, one or more outputs 640. Outputs 640 may be presented to users for example trough user interfaces and/or GUIs. In some embodiments, external feedback 635 may be received users as a function of output 640.

With continued reference to FIG. 6, one or more, processes, machine-learning processes, actions, steps, or the like as disclosed above may be performed using dedicated hardware 655. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware 655 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware 655 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware 655 to perform one or more operations described herein, such as evaluation of model and/or algorithm outputs, one-time or iterative updates to parameters, coefficients, weights, and/or biases, and/or any other operations such as vector and/or matrix operations as described in this disclosure.

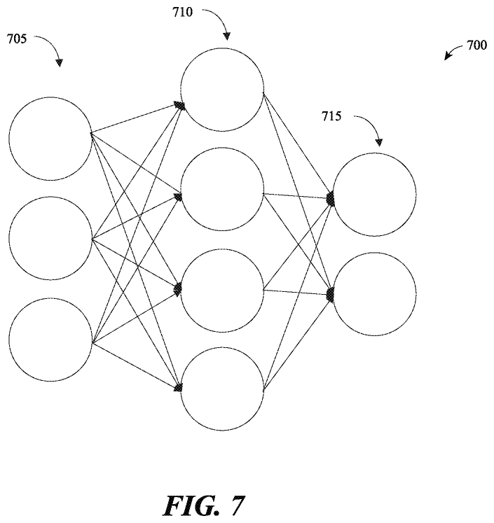

Referring now to FIG. 7, an exemplary embodiment of neural network 700 is illustrated. A neural network 700 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 705, one or more intermediate layers 710, and an output layer of nodes 715. Connections between nodes may be created using a process of “training” the network, in which elements from a training dataset may applied to the input nodes. A suitable training algorithm (such as Levenberg-Marquardt, conjugate gradient, simulated annealing, or other algorithms) may then be used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

### Method for GPU-Accelerated Cost Calculation

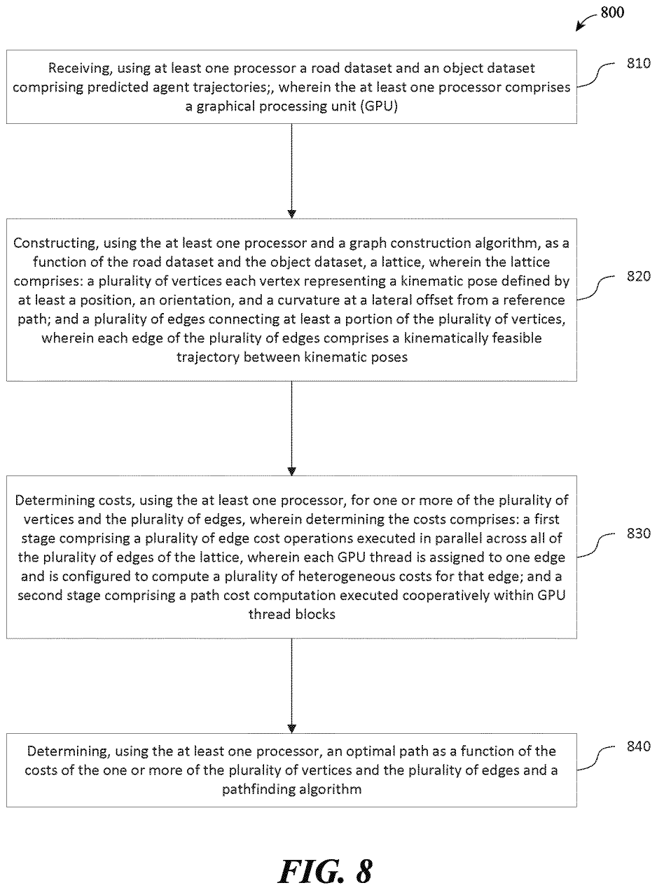

Referring now to FIG. 8, a method 800 for GPU-accelerated cost calculation is shown. Method 800 includes a step 810 of receiving, using at least one processor a road dataset and an object dataset including predicted agent trajectories, wherein the at least one processor includes a graphical processing unit (GPU). This may be performed, without limitation, as described with reference to any of FIGS. 1-8.

With continued reference to FIG. 8, method 800 includes a step 820 of constructing, using the at least one processor and a graph construction algorithm, as a function of the road dataset and the object dataset, a lattice, wherein the lattice includes: a plurality of vertices each vertex representing a kinematic pose defined by at least a position, an orientation, and a curvature at a lateral offset from a reference path; and a plurality of edges connecting at least a portion of the plurality of vertices, wherein each edge of the plurality of edges includes a kinematically feasible trajectory between kinematic poses. This may be performed, without limitation, as described with reference to any of FIGS. 1-8.

With continued reference to FIG. 8, method 800 includes a step 830 of determining costs, using the at least one processor, for one or more of the plurality of vertices and the plurality of edges, wherein determining the costs includes: a first stage including a plurality of edge cost operations executed in parallel across all of the plurality of edges of the lattice, wherein each GPU thread is assigned to one edge and is configured to compute a plurality of heterogeneous costs for that edge; and a second stage including a path cost computation executed cooperatively within GPU thread blocks. This may be performed, without limitation, as described with reference to any of FIGS. 1-8.

With continued reference to FIG. 8, method 800 includes a step 840 of determining, using the at least one processor, an optimal path as a function of the costs of the one or more of the plurality of vertices and the plurality of edges and a pathfinding algorithm. This may be performed, without limitation, as described with reference to any of FIGS. 1-8.

In some aspects, the techniques described herein relate to a method, further including determining an agent distance grid, including: resampling each predicted trajectory to a uniform temporal resolution, wherein the predicted agent trajectories include agent states at temporal points, at least a position, an orientation, and a polygonal footprint; and for each temporal point, using the graphical processing unit, rasterizing the polygonal footprints associated with that temporal point into a two-dimensional distance grid, wherein determining the optimal path as a function of the costs of the one or more of the plurality of vertices and the plurality of edges and the pathfinding algorithm includes determining the optimal path as a function of the two-dimensional distance grids.

In some aspects, the techniques described herein relate to a method, wherein the second stage further includes: jointly computing, using threads within a GPU thread block, a dynamic agent margin cost for each of a plurality of sample poses along candidate edges; storing the dynamic agent margin costs in thread-block shared memory; independently computing, by each thread within the GPU thread block, a path cost for a discretized speed index, as a function of the dynamic agent margin costs from the thread-block shared memory and the edge costs from the first stage.

In some aspects, the techniques described herein relate to a method, wherein the plurality of heterogeneous costs of the first stage includes an obstacle margin cost derived from querying a static obstacle distance grid at a plurality of sample points along an edge of the static obstacle distance grid.

In some aspects, the techniques described herein relate to a method, wherein querying the static obstacle distance grid at the plurality of sample points includes evaluating each sample point of the plurality of sample points using a vehicle shape decomposed into a set of circles, wherein each grid value is queried at each circle center.

In some aspects, the techniques described herein relate to a method, wherein: each edge of the plurality of edges represents a smooth trajectory between kinematic poses; and each vertex of the plurality of vertices represents a kinematic pose at lateral offsets along a reference path.

In some aspects, the techniques described herein relate to a method, wherein determining the costs, includes: a first stage including edge cost calculation, wherein all edge cost calculations are run in parallel for all of the plurality of edges; and a second stage including path cost calculation.

In some aspects, the techniques described herein relate to a method, wherein: the method further includes receiving, using the at least one processor a traffic rule data; and constructing the lattice includes constructing, using a graph construction algorithm, a lattice as a function of the road dataset, the object dataset, and the traffic rule data.

In some aspects, the techniques described herein relate to a method, wherein the pathfinding algorithm includes a forward dynamic programming sweep over the lattice vertices ordered by milestone index and discretized speed.

In some aspects, the techniques described herein relate to a method, further including configuring, using the at least one processor, an autonomous vehicle to execute the optimal path.

In some aspects, the techniques described herein relate to a method, wherein: the first cost value includes a kinematic cost; and the second cost value includes a lane positioning cost.

In some aspects, the techniques described herein relate to a method, wherein determining the costs for the one or more of the plurality of vertices and the plurality of edges includes calculating a third cost value using a third graphical processing unit thread.

In some aspects, the techniques described herein relate to a method, wherein: the first cost value includes a kinematic cost; the second cost value includes a lane positioning cost; and the third cost value includes an object margin cost.

In some aspects, the techniques described herein relate to a method, wherein the steps of: calculating a first cost value using a first graphical processing unit thread; and calculating a second cost value using a second graphical processing unit thread, are processed in parallel.

In some aspects, the techniques described herein relate to a method, wherein: each edge of the plurality of edges represents a smooth trajectory between kinematic poses; and each vertex of the plurality of vertices represents a kinematic pose at lateral offsets along a reference path.

In some aspects, the techniques described herein relate to a method, wherein determining the costs, includes: a first stage including edge cost calculation, wherein all edge cost calculations are run in parallel for all of the plurality of edges; and a second stage including path cost calculation.

In some aspects, the techniques described herein relate to a method, wherein: the method further includes receiving, using the at least one processor a traffic rule data; and constructing the lattice includes constructing, using a graph construction algorithm, a lattice as a function of the road dataset, the object dataset, and the traffic rule data.

In some aspects, the techniques described herein relate to a method, wherein the pathfinding algorithm includes a forward dynamic programming sweep.

In some aspects, the techniques described herein relate to a method, further including configuring, using the at least one processor, an autonomous vehicle to execute the optimal path.

### An Exemplary Computing Device in the Exemplary Form of a Computer System

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 9 shows a diagrammatic representation of one embodiment of a computing device in the exemplary form of a computer system 900 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 900 includes a processor 905 and a memory 910 that communicate with each other, and with other components, via a bus 915. Bus 915 may include any of several types of bus structures including, but not limited to, a memory bus, a memory controller, a peripheral bus, a local bus, and any combinations thereof, using any of a variety of bus architectures.

Processor 905 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 905 may be organized according to Von Neumann and/or Harvard architecture as a non-limiting example. Processor 905 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 910 may include various components (e.g., machine-readable media) including, but not limited to, a random-access memory component, a read only component, and any combinations thereof. In one example, a basic input/output system 920 (BIOS), including basic routines that help to transfer information between elements within computer system 900, such as during start-up, may be stored in memory 910. Memory 910 may also include (e.g., stored on one or more machine-readable media) instructions (e.g., software) 925 embodying any one or more of the aspects and/or methodologies of the present disclosure. In another example, memory 910 may further include any number of program modules including, but not limited to, an operating system, one or more application programs, other program modules, program data, and any combinations thereof. Memory 910 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 900 may also include a storage device 930. Examples of a storage device (e.g., storage device 930) include, but are not limited to, a hard disk drive, a magnetic disk drive, an optical disc drive in combination with an optical medium, a solid-state memory device, and any combinations thereof. Storage device 930 may be connected to bus 915 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 930 (or one or more components thereof) may be removably interfaced with computer system 900 (e.g., via an external port connector (not shown)). Particularly, storage device 930 and an associated machine-readable medium may provide nonvolatile and/or volatile storage of machine-readable instructions, data structures, program modules, and/or other data for computer system 900. In some embodiments, storage device 930 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software (e.g., instructions 925) may reside, completely or partially, within machine-readable medium. In another example, software may reside, completely or partially, within processor 905.

Computer system 900 may also include an input device 940. In one example, a user of computer system 900 may enter commands and/or other information into computer system 900 via input device 940. Examples of an input device 940 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 940 may be interfaced to bus 915 via any of a variety of interfaces (not shown) including, but not limited to, a serial interface, a parallel interface, a game port, a USB interface, a FIREWIRE interface, a direct interface to bus 915, and any combinations thereof. Input device 940 may include a touch screen interface that may be a part of or separate from display 945, discussed further below. Input device 940 may be utilized as a user selection device for selecting one or more graphical representations in a graphical interface as described above.

A user may also input commands and/or other information to computer system 900 via storage device 930 (e.g., a removable disk drive, a flash drive, etc.) and/or network interface device 950. A network interface device, such as network interface device 950, may be utilized for connecting computer system 900 to one or more of a variety of networks, such as network 955, and one or more remote devices 960 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 955, may employ a wired and/or a wireless mode of communication. In general, any network topology may be used. Information (e.g., data, software, etc.) may be communicated to and/or from computer system 900 via network interface device 950.

Computer system 900 may further include a video display adapter 965 for communicating a displayable image to a display device, such as display 945. Examples of a display device include, but are not limited to, a liquid crystal display (LCD), a cathode ray tube (CRT), a plasma display, a light emitting diode (LED) display, and any combinations thereof. Display adapter 965 and display 945 may be utilized in combination with processor 905 to provide graphical representations of aspects of the present disclosure. In addition to a display device, computer system 900 may include one or more other peripheral output devices including, but not limited to, an audio speaker, a printer, and any combinations thereof. Such peripheral output devices may be connected to bus 915 via a peripheral interface 970. Examples of a peripheral interface include, but are not limited to, a serial port, a USB connection, a FIREWIRE connection, a parallel connection, and any combinations thereof.

Further referring to FIG. 9, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 9, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 9, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 900, processor 905, and memory 910 may be virtualized; that is, a virtual machine and/or container may interact directly with such computing system 900, processor 905, and/or memory 910, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 905 comprises a plurality of processors and/or processor cores, virtualization may, in some cases, simulate or emulate a single (virtual) processor whose functions are allocated to one or more of the plurality of processors and/or processor cores. In this case, while processor 905 may be said to be virtualized, the processor 905, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, as discussed above, it should be understood that the particular methods and systems used to implement the disclosure may be modified without changing the spirit of the disclosure, and as such the various art-recognized alternatives are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. A system for GPU-accelerated cost calculation, the system comprising:
at least one processor comprising a graphical processing unit (GPU); and
a memory communicatively connected to the at least one processor and containing instructions configuring the at least a processor to:
receive a road dataset and an object dataset comprising predicted agent trajectories;
construct, using a graph construction algorithm, as a function of the road dataset and the object dataset, a lattice, wherein the lattice comprises:
a plurality of vertices each vertex representing a kinematic pose defined by at least a position, an orientation, and a curvature at a lateral offset from a reference path; and
a plurality of edges connecting at least a portion of the plurality of vertices, wherein each edge of the plurality of edges comprises a kinematically feasible trajectory between kinematic poses;
determine costs for one or more of the plurality of vertices and the plurality of edges, wherein determining the costs comprises:
a first stage comprising a plurality of edge cost operations executed in parallel across all of the plurality of edges of the lattice, wherein each GPU thread is assigned to one edge and is configured to compute a plurality of heterogeneous costs for that edge; and
a second stage comprising a path cost computation executed cooperatively within GPU thread blocks; and
determine an optimal path as a function of the costs of the one or more of the plurality of vertices and the plurality of edges and a pathfinding algorithm.

2. The system of claim 1, wherein the memory contains instructions further configuring the at least a processor to determine an agent distance grid comprising:
resampling each predicted trajectory to a uniform temporal resolution, wherein the predicted agent trajectories comprise agent states at temporal points, at least a position, an orientation, and a polygonal footprint; and
for each temporal point, using the graphical processing unit, rasterizing the polygonal footprints associated with that temporal point into a two-dimensional distance grid, wherein determining the optimal path as a function of the costs of the one or more of the plurality of vertices and the plurality of edges and the pathfinding algorithm comprises determining the optimal path as a function of the two-dimensional distance grids.

3. The system of claim 1, wherein the second stage further comprises:
jointly computing, using threads within a GPU thread block, a dynamic agent margin cost for each of a plurality of sample poses along candidate edges;
storing the dynamic agent margin costs in thread-block shared memory;
independently computing, by each thread within the GPU thread block, a path cost for a discretized speed index, as a function of the dynamic agent margin costs from the thread-block shared memory and the edge costs from the first stage.

4. The system of claim 1, wherein the plurality of heterogeneous costs of the first stage comprises an obstacle margin cost derived from querying a static obstacle distance grid at a plurality of sample points along an edge of the static obstacle distance grid.

5. The system of claim 4, wherein querying the static obstacle distance grid at the plurality of sample points comprises evaluating each sample point of the plurality of sample points using a vehicle shape decomposed into a set of circles, wherein each grid value is queried at each circle center.

6. The system of claim 1, wherein:
each edge of the plurality of edges represents a smooth trajectory between kinematic poses; and
each vertex of the plurality of vertices represents a kinematic pose at lateral offsets along a reference path.

7. The system of claim 1, wherein determining the costs, comprises:
a first stage comprising edge cost calculation, wherein all edge cost calculations are run in parallel for all of the plurality of edges; and
a second stage comprising path cost calculation.

8. The system of claim 1, wherein:
the memory contains instructions further configuring the at least one processor to receive, a traffic rule data; and
constructing the lattice comprises constructing, using a graph construction algorithm, a lattice as a function of the road dataset, the object dataset, and the traffic rule data.

9. The system of claim 1, wherein the pathfinding algorithm comprises a forward dynamic programming sweep over the lattice vertices ordered by milestone index and discretized speed.

10. The system of claim 1, wherein the memory contains instructions further configuring the at least one processor to configure an autonomous vehicle to execute the optimal path.

11. A method for GPU-accelerated cost calculation, the method comprising:
receiving, using at least one processor a road dataset and an object dataset comprising predicted agent trajectories, wherein the at least one processor comprises a graphical processing unit (GPU);
constructing, using the at least one processor and a graph construction algorithm, as a function of the road dataset and the object dataset, a lattice, wherein the lattice comprises:
a plurality of vertices each vertex representing a kinematic pose defined by at least a position, an orientation, and a curvature at a lateral offset from a reference path; and
a plurality of edges connecting at least a portion of the plurality of vertices, wherein each edge of the plurality of edges comprises a kinematically feasible trajectory between kinematic poses; and
determining costs, using the at least one processor, for one or more of the plurality of vertices and the plurality of edges, wherein determining the costs comprises:
a first stage comprising a plurality of edge cost operations executed in parallel across all of the plurality of edges of the lattice, wherein each GPU thread is assigned to one edge and is configured to compute a plurality of heterogeneous costs for that edge; and
a second stage comprising a path cost computation executed cooperatively within GPU thread blocks; and
determining, using the at least one processor, an optimal path as a function of the costs of the one or more of the plurality of vertices and the plurality of edges and a pathfinding algorithm.

12. The method of claim 11, further comprising determining an agent distance grid, comprising:
resampling each predicted trajectory to a uniform temporal resolution, wherein the predicted agent trajectories comprise agent states at temporal points, at least a position, an orientation, and a polygonal footprint; and
for each temporal point, using the graphical processing unit, rasterizing the polygonal footprints associated with that temporal point into a two-dimensional distance grid, wherein determining the optimal path as a function of the costs of the one or more of the plurality of vertices and the plurality of edges and the pathfinding algorithm comprises determining the optimal path as a function of the two-dimensional distance grids.

13. The method of claim 11, wherein the second stage further comprises:
jointly computing, using threads within a GPU thread block, a dynamic agent margin cost for each of a plurality of sample poses along candidate edges;
storing the dynamic agent margin costs in thread-block shared memory;
independently computing, by each thread within the GPU thread block, a path cost for a discretized speed index, as a function of the dynamic agent margin costs from the thread-block shared memory and the edge costs from the first stage.

14. The method of claim 11, wherein the plurality of heterogeneous costs of the first stage comprises an obstacle margin cost derived from querying a static obstacle distance grid at a plurality of sample points along an edge of the static obstacle distance grid.

15. The method of claim 14, wherein querying the static obstacle distance grid at the plurality of sample points comprises evaluating each sample point of the plurality of sample points using a vehicle shape decomposed into a set of circles, wherein each grid value is queried at each circle center.

16. The method of claim 11, wherein:
each edge of the plurality of edges represents a smooth trajectory between kinematic poses; and
each vertex of the plurality of vertices represents a kinematic pose at lateral offsets along a reference path.

17. The method of claim 11, wherein determining the costs, comprises:
a first stage comprising edge cost calculation, wherein all edge cost calculations are run in parallel for all of the plurality of edges; and
a second stage comprising path cost calculation.

18. The method of claim 11, wherein:
the method further comprises receiving, using the at least one processor a traffic rule data; and
constructing the lattice comprises constructing, using a graph construction algorithm, a lattice as a function of the road dataset, the object dataset, and the traffic rule data.

19. The method of claim 11, wherein the pathfinding algorithm comprises a forward dynamic programming sweep over the lattice vertices ordered by milestone index and discretized speed.

20. The method of claim 11, further comprising configuring, using the at least one processor, an autonomous vehicle to execute the optimal path.
